(19) United States
(12) Patent Application Publication
(10) Pub. No.: US 2022/0112319 A1
(43) Pub. Date: Apr. 14, 2022

(54) COMPOSITE FILM, METHOD OF MAKING THE SAME, AND ARTICLE INCLUDING THE SAME

(71) Applicant: 3M INNOVATIVE PROPERTIES COMPANY, St. Paul, MN (US)

(72) Inventors: Timothy J. Hebrink, Scandia, MN (US); Jeffrey O. Emslander, City of Grant, MN (US); Katelyn M. Leniczek, St. Paul, MN (US); Jacob D. Young, St. Paul, MN (US); Darrin H. Lee, Pine City, MN (US); Chris R. Birkholz, Forest Lake, MN (US); Jinsheng Zhou, Woodbury, MN (US); Pingfan Wu, Woodbury, MN (US); Derek J. Dehn, Maplewood, MN (US); Christopher J. Rother, Hudson, WI (US)

(21) Appl. No.: 17/298,218

(22) PCT Filed: Nov. 19, 2019
(86) PCT No.: PCT/IB2019/059944

§ 371 Date: May 28, 2021

Related U.S. Application Data
(60) Provisional application No. 62/772,898, filed on Nov. 29, 2018.

(51) Int. Cl. C08F 214/26; C08F 214/22; C08F 214/28; B29C 48/08; B29C 48/18; C08F 220/06; C08F 210/02

(52) U.S. Cl. CPC C08F 214/26; C08F 214/22; C08F 214/28; B29K 2027/16; B29C 48/18; C08F 220/06; C08F 210/02; B29C 48/08

(57) ABSTRACT

A composite film comprises first and second layers. The first layer comprises a first copolymer of monomers comprising tetrafluoroethylene, hexafluoropropylene, and vinylidene fluoride, wherein the first copolymer contains at least 35 mole percent of vinylidene fluoride monomer units. The second layer is disposed on the first layer, and comprises a second copolymer comprising 50 to 83 weight percent of ethylene monomer units and at least 17 weight percent of alkyl (meth)acrylate monomer units represented by the formula (I) wherein R¹ is H or methyl, and each R² is independently an alkyl group having from 1 to 4 carbon atoms. Methods of making the composite film and articles including it are also disclosed.

### TECHNICAL FIELD

The present disclosure broadly relates to composite films including a fluoropolymer layer.

### BACKGROUND

Fluoropolymer films are useful, for example, for their outdoor durability, fire resistance, chemical resistance, water repellency, stain resistance, and graffiti resistance. However, fluoropolymers can be difficult to adhere to many polymers without the use of an etching treatment or an adhesion promoter. There remains a need for new methods for adhering fluoropolymer films to non-fluorinated polymeric films.

### SUMMARY

Advantageously, the present inventors have discovered that composite films having a fluoropolymer layer disposed on and bonded to an ethylene alkyl (meth) acrylate copolymer layer bond well to many polymers, thereby providing a route to bonding fluoropolymers to non-fluorinated polymers.

In one aspect, the present disclosure provides a composite film comprising:
a first layer comprising a first copolymer of monomers comprising tetrafluoroethylene, hexafluoropropylene, and vinylidene fluoride, wherein the first copolymer contains at least 15 mole percent of vinylidene fluoride monomer units; and
a second layer disposed on the first layer, wherein the second layer comprises a second copolymer of comprising 50 to 83 weight percent of ethylene monomer units (i.e., —CH₂CH₂—) and at least 17 weight percent of alkyl (meth)acrylate monomer units represented by the formula

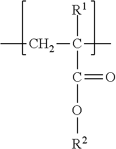

wherein R¹ is H or methyl, and each R² is independently an alkyl group having from 1 to 4 carbon atoms.

Composite films according to the present disclosure can be incorporated in various articles.

Accordingly, in another aspect, the present disclosure provides a heat-sealable protective article comprising the composite film according to the present disclosure in the form of a tube or pouch, wherein upon heat sealing the heat-sealable protective article to itself, a volume is enclosed that is bounded by the composite film and at least one heat-sealed bond.

In yet another aspect, the present disclosure provides an article comprising a substrate disposed within an optionally heat-sealed heat-sealable protective article according to the present disclosure.

In yet another aspect, the present disclosure provides a method of making a composite film, the method comprising coextruding:
a first layer comprising a first copolymer of monomers comprising tetrafluoroethylene, hexafluoropropylene, and vinylidene fluoride, wherein the first copolymer contains at least 15 mole percent of vinylidene fluoride monomer units; and
a second layer in intimate contact with the first layer, wherein the second layer comprises a second copolymer comprising 50 to 83 weight percent of ethylene monomer units and at least 17 weight percent of alkyl (meth)acrylate monomer units represented by the formula

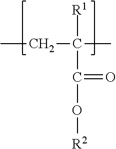

wherein R¹ is H or methyl, and each R² is independently an alkyl group having from 1 to 4 carbon atoms.

As used herein:

the term “mole percent” in reference to monomer or monomer unit mixtures is calculated based on the total number of moles of monomer or monomer unit, respectively, that is present.

the term “monomer unit” refers to the largest constitutional unit contributed by a monomer molecule to the structure of an oligomer or polymer; and

the term “vinylidene fluoride” refers to the compound H₂C═CF₂.

Features and advantages of the present disclosure will be further understood upon consideration of the detailed description as well as the appended claims.

### BRIEF DESCRIPTION OF THE DRAWINGS

FIG. 1 is a schematic side view of an exemplary composite film 100 according to the present disclosure.

FIG. 2 is a schematic side view of an exemplary composite film 200 according to the present disclosure.

FIG. 3 is a schematic perspective view of a heat-sealable tube 300 according to the present disclosure

FIG. 4A is a schematic top view of exemplary article 400 according to the present disclosure.

FIG. 4B is a schematic end view of article 400 according to the present disclosure.

FIG. 4C is a schematic cross-sectional view of article 400 taken along line 4C-4C.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

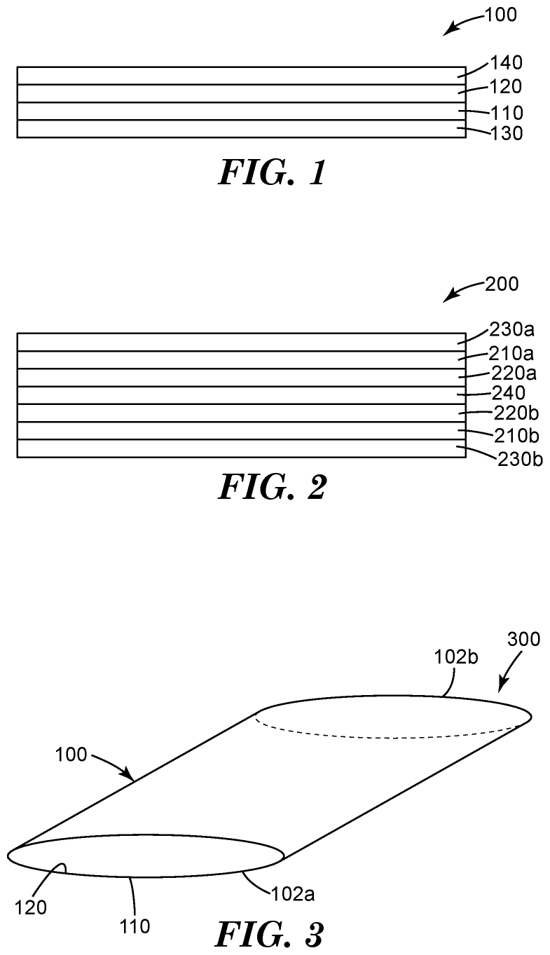

FIG. 1 shows a composite film 100 according to the present disclosure. Referring now to FIG. 1, composite film 100 comprises first layer 110 comprising a first copolymer of monomers comprising tetrafluoroethylene, hexafluoropropylene, and vinylidene fluoride, wherein the first copolymer contains at least 15 mole percent of vinylidene fluoride monomer units. Second layer 120 is disposed on first layer 110. Second layer 120 comprises a second copolymer of comprising 50 to 83 weight percent of ethylene monomer units and at least 17 weight percent of alkyl (meth)acrylate monomer units represented by the formula

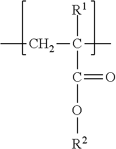

wherein R¹ is H or methyl, and each R² is independently an alkyl group having from 1 to 4 carbon atoms.

Optional third layer 130 is disposed on first layer 110 opposite second layer 120. Third layer 130 comprises a third copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units. Optional fourth layer 140 is disposed on second layer 120 opposite first layer 110. Fourth layer 140 comprises a non-fluorinated polymer.

First layer 110 comprises a first copolymer of monomers comprising tetrafluoroethylene, hexafluoropropylene, and vinylidene fluoride, wherein the first copolymer contains at least 15 mole percent of vinylidene fluoride monomer units.

In some embodiments, the first copolymer contains 15 to 80 mole percent of tetrafluoroethylene monomer units, 5 to 17 mole percent of hexafluoropropylene monomer units, and 15 to 50 mole percent of vinylidene fluoride monomer units, wherein the total molar amount of the monomer units equals 100 percent. In some embodiments, the first copolymer contains 55 to 80 mole percent of tetrafluoroethylene monomer units, 5 to 12 mole percent of hexafluoropropylene monomer units, and 15 to 33 mole percent of vinylidene fluoride monomer units, wherein the total molar amount of the monomer units equals 100 percent. In some preferred embodiments, the first copolymer consists of tetrafluoroethylene monomer units, hexafluoropropylene monomer units, and vinylidene fluoride monomer units.

In some embodiments, the first copolymer may also include one or more additional monomers such as, for example, perfluoro(methyl vinyl ether), perfluoro (ethyl vinyl ether), and perfluoro(propyl vinyl ether). In such cases the additional monomer is typically present in an amount of less than 5 mole percent, preferably less than 3 mole percent, based on the total number of moles of monomer units in the first copolymer.

Copolymers containing tetrafluoroethylene, hexafluoropropylene, and vinylidene fluoride, and methods of making them, are known in the art; for example, as described in U.S. Pat. No. 5,512,225 (Fukushi); U.S. Pat. No. 5,549,948 (Blong et al.); U.S. Pat. No. 5,552,199 (Blong et al.); U.S. Pat. No. 5,656,121 (Fukushi); U.S. Pat. No. 6,242,548 (Duchesne et al.); U.S. Pat. No. 6,489,420 (Duchesne et al.); and U.S. Pat. No. 6,693,152 (Kaspar et al.).

Commercially available copolymers containing 35 to 80 mole percent of tetrafluoroethylene, 5 to 17 mole percent of hexafluoropropylene monomer units, and 15 to 50 mole percent of vinylidene fluoride monomer units, and optionally other perfluorinated monomers, wherein the total molar amount of the monomer units equals 100 percent include, for example, those available from 3M Company under the trade designation 3M DYNEON FLUOROPLASTIC THV. Exemplary suitable grades for inclusion in the first layer include those identified as THV 220, THV 221, THV 310, THV 415, THV 500, THV 610, THV 700, THV 810, THV 815, and THV 900.

The first layer may have any thickness, but is preferably relatively thin in order to minimize the amount of fluoropolymer used. For example, the first layer may have a thickness of from 0.01 microns to 0.5 millimeter, or more.

Second layer 120 comprises a second copolymer. The second copolymer can be made, for example, by copolymerization of monomers comprising ethylene and alkyl (meth)acrylate monomer(s) represented by the formula

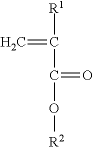

wherein R¹ is H or methyl, and each R² is independently an alkyl group having from 1 to 4 carbon atoms. Examples of R² include methyl, ethyl, propyl, and butyl. Some preferred alkyl (meth)acrylate monomers are methyl acrylate, ethyl acrylate, methyl methacrylate, and butyl acrylate.

In some embodiments, the second copolymer comprises 17 to 45 weight percent, 17 to 35 weight percent, 17 to 30 weight percent, or even 17 to 25 weight percent of the alkyl (meth)acrylate monomer units. In some embodiments, the second copolymer comprises 55 to 83 weight percent, 65 to 83 weight percent, 70 to 83 weight percent, or even 75 to 83 weight percent of ethylene monomer units.

In some embodiments, the second copolymer contains 18 to 50 weight percent of alkyl (meth) acrylate-derived monomer units and 50 to 82 weight percent of ethylene monomer units, based on the total weight of the second copolymer. In some embodiments, the second copolymer contains 25 to 50 weight percent of alkyl (meth) acrylate-derived monomer units and 50 to 75 weight percent of ethylene monomer units, based on the total weight of the second copolymer.

Copolymers of ethylene and alkyl (meth)acrylates (e.g., methyl acrylate, methyl methacrylate, ethyl acrylate, butyl acrylate) can be prepared by known methods; for example, as described in U.S. Pat. No. 3,350,372 (Anspon et al.). Ethylene-co-methyl acrylate copolymers are also widely available from commercial sources. Examples of suitable ethylene-co-methyl acrylate copolymers include those available from DuPont under the trade designation ELVALOY such as, for example, ELVALOY AC 1209 (ethylene-co-methyl acrylate (91:9 wt.:wt.) copolymer), ELVALOY 1609 AC (ethylene-co-methyl acrylate (91:9 wt.:wt.) copolymer), ELVALOY AC 1913 (ethylene-co-methyl acrylate (87:13 wt.:wt.) copolymer), ELVALOY 1218 AC (ethylene-co-methyl acrylate (82:18 wt.:wt.) copolymer), ELVALOY AC 1820 (ethylene-co-methyl acrylate (80:20 wt.:wt.) copolymer), ELVALOY AC 12024S (ethylene-co-methyl acrylate (76:24 wt.:wt.) copolymer), ELVALOY AC 1224 (ethylene-co-methyl acrylate (76:24 wt.:wt.) copolymer), ELVALOY AC 15024S (ethylene-co-methyl acrylate (76:24 wt.:wt.) copolymer), and ELVALOY 1125 AC (ethylene-co-methyl acrylate (75:25 wt.:wt.) copolymer).

The second layer may have any thickness, but is preferably relatively thin in order to minimize the amount of fluoropolymer used. For example, the first layer may have a thickness of from 0.01 microns to 0.5 millimeter, or more.

Optional third layer 130 comprises a third copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units.

In some embodiments, the third copolymer contains 35 to 80 mole percent, preferably 50 to 80 mole percent, and more preferably 70 to 80 mole percent of tetrafluoroethylene monomer units, wherein the total molar amount of the monomer units equals 100 percent. In some embodiments, the third copolymer contains 5 to 20 mole percent, preferably 5 to 10 mole percent of hexafluoropropylene monomer units, wherein the total molar amount of the monomer units equals 100 percent. In some embodiments, the third copolymer contains 15 to 50 mole percent, preferably 15 to 35 mole percent and more preferably 15 to 20 weight percent of vinylidene fluoride monomer units, wherein the total molar amount of the monomer units equals 100 percent. In some embodiments, the third copolymer contains 70 to 80 mole percent of tetrafluoroethylene monomer units, 5 to 10 mole percent of hexafluoropropylene monomer units, and 15 to 20 mole percent of vinylidene fluoride monomer units, wherein the total molar amount of the monomer units equals 100 percent. In some embodiments, the third copolymer contains 70 to 80 mole percent of tetrafluoroethylene monomer units, 15 to 20 mole percent of vinylidene fluoride monomer units, and 5 to 9 mole percent of hexafluoropropylene monomer units. In some preferred embodiments, the third copolymer consists of tetrafluoroethylene monomer units, hexafluoropropylene monomer units, and vinylidene fluoride monomer units.

In some embodiments, the third copolymer may also include one or more additional monomers such as, for example, perfluoro(methyl vinyl ether), perfluoro (ethyl vinyl ether), and perfluoro(propyl vinyl ether). In such cases the additional monomer is typically present in an amount of less than 5 mole percent, preferably less than 3 mole percent, based on the total number of moles of monomer units in the first copolymer.

Suitable methods for preparing the third copolymer are described hereinabove in the discussion of making the first copolymer.

Suitable commercially available copolymers containing 50 to 80 mole percent of tetrafluoroethylene, 5 to 12 mole percent of hexafluoropropylene monomer units, and 15 to 33 mole percent of vinylidene fluoride monomer units, and optionally other perfluorinated monomers, wherein the total molar amount of the monomer units equals 100 percent are likewise described hereinabove in the discussion of the first copolymer.

The third layer may have any thickness, but is preferably relatively thin in order to minimize the amount of fluoropolymer used. For example, the first layer may have a thickness of from 0.01 microns to 0.5 millimeter, or more.

Optional fourth layer 140 comprises a non-fluorinated polymer. The non-fluorinated polymer may be a thermoset and/or a thermoplastic non-fluorinated polymer, more preferably a thermoplastic non-fluorinated polymer. More preferably, the fourth layer is thermoplastic or a pressure-sensitive adhesive.

Exemplary thermoplastic polymers include: polyolefins (e.g., polyethylene, polypropylene, polybutylene, polystyrene); polyacrylates (e.g., poly(methyl methacrylate)); polyamides (e.g., nylon 6, nylon 6,6); polyimides; polycarbonates (e.g., polycarbonates of bisphenol A); polyesters (e.g., polycaprolactone, polyethylene terephthalate, polyethylene naphthalate); poly(vinyl chloride); thermoplastic polyurethanes; styrene-acrylonitrile copolymers, silicone-polyoxamide polymers, cyclic olefin copolymers, ethylene-vinyl acetate copolymers, ethylene-acrylic copolymers,

In some embodiments, the optional fourth layer is a pressure-sensitive adhesive, which may be a hot melt, spray coated, or solvent-coated adhesive, for example. Examples of pressure-sensitive adhesive include: acrylic pressure-sensitive adhesives, silicon pressure-sensitive adhesives, natural rubber pressure-sensitive adhesives, synthetic rubber pressure-sensitive adhesives, and urethane pressure-sensitive adhesives. In addition, either type of pressure-sensitive adhesives from permanent pressure-sensitive adhesives and removable pressure-sensitive adhesives can be used. When a pressure-sensitive adhesive is present the composite film can be an adhesive tape or a label protector, for example.

In some embodiments, the composite film includes additional layers. Referring now to FIG. 2, exemplary composite film 200 comprises seven layers. In addition to the first to fourth layers (210a, 220a, 230a, 240) corresponding to respective layers 110, 120, 130, 140 discussed above, optional fifth, sixth, and seventh layers (220b, 210b, 230b) are also present. Layers 210b, 220b, and 230b respectively correspond compositionally to layers 110, 120, and 130 in FIG. 1, and may be identical to, or compositional different (i.e., while still falling within their broadest compositional boundaries) layers 210a, 220a, and 230a. For example, while layers 210a and 210b both fall within the compositional boundaries of layer 110 they can have the same or different compositions. Likewise, they may have different thicknesses.

In some embodiments, the composite film may be shaped into a heat-sealable protective article such as a tube or pouch, for example. FIG. 3 shows a heat-sealable tube 300, formed of composite film 100, formed of first and second layers 110 and 120, and which can be heat-sealed at opposite ends 302a, 302b. The term “heat-seal” (e.g., as used in heat-sealed and heat-sealable) refers to a process in which thermal energy and optionally pressure are used to form a seal. Sources of thermal energy include conduction heating, convection heating, infrared heating, ultrasonic welding, radiofrequency (Rf) welding via dielectric heating, and combinations thereof. Such methods are well-known to those of skill in the art.

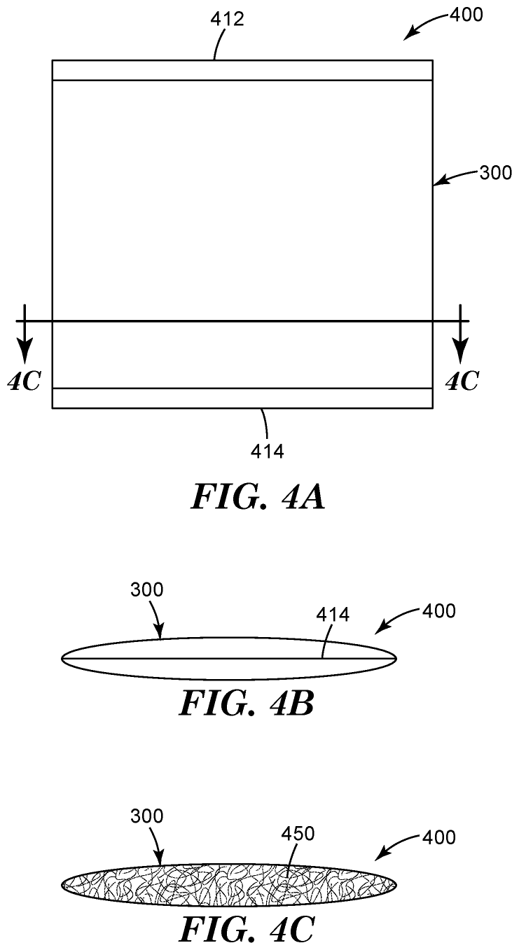

In one embodiment, the above procedure can be used to make an article 400 (see FIGS. 4A-4C) comprising a substrate 450 (shown as a lofty open nonwoven fiber web) disposed within an optionally heat-sealed heat-sealable tube 300. Upon heat-sealing the heat-sealable protective article to itself to make a heat-sealed protective article 400, a volume is at least partially bounded by heat-sealable tube 300 and optional heat-sealed bonds 412, 414. Heat-sealable tube 300 can be formed using convention extrusion techniques known to those skilled in the art.

Exemplary substrates include wood; paper; natural and/or synthetic fibers which may be woven, nonwoven, and/or loose; furniture; fiber-polymer composite boards; panels (including composite panels); polymer films; polymer foam; polymer mesh; polymer pipes; polymer tubes; cross-linked polymer composites; metal mesh; metal fibers; metal wires; ceramic fibers; glass fibers; and combinations thereof. Particle-filled composite substrates may include, for example, intumescent and endothermic additives.

Typically, the substrate will have greater flammability than the heat-sealable tube 300, which affords the substrate a degree of protection; however, this is not a requirement.

Exemplary fiber webs may be lofty and open of the type used for thermal and/or acoustic insulation. Exemplary nonwoven fiber webs may comprise bio-based and/or natural fibers and/or synthetic fibers. Exemplary bio-based and/or natural fibers include cotton, wool, jute, agave, sisal, coconut, soybean, hemp, viscose, and/or bamboo. Exemplary synthetic fibers include polypropylene fibers, polyethylene fibers, polybutylene fibers, polyethylene terephthalate fibers, polybutylene terephthalate fibers, polyethylene naphthalate fibers, polyamide fiber, polyurethane fibers, polylactic acid fibers, polyvinyl alcohol fibers, polyphenylene sulfide fibers, polysulfone fibers, liquid crystalline polymer fibers, poly(ethylene-co-vinyl acetate) fibers, polyacrylonitrile fibers, oxidized polyacrylonitrile carbon fibers, cyclic polyolefin fibers, polyoxymethylene fibers, thermoplastic elastomers, and combinations thereof. The fibers may include continuous and/or staple fibers, which may be crimped, thermally bonded, and or needletacked, for example. The fibers may also include intumescent and endothermic particles or additives. In one embodiment, the nonwoven fiber web can be THINSULATE synthetic fiber thermal insulation from 3M Company.

Composite films according to the present disclosure can be made by various techniques including coextrusion and heat lamination, for example. Coextrusion refers to the simultaneous melt processing of multiple molten streams and the combination of such molten streams into a single unified structure, or coextruded film, for example from a single extrusion die. The process is run generally by processing the feedstocks at or above their melt temperature through the die, resulting in the coextruded film. A coextruded film is generally a composite of all the molten feedstocks placed within the co-extrusion process. The resulting co-extruded films are generally multilayer. The layers are in contact with one another in the molten state. In certain embodiments, the layers are in contact throughout the extrusion, for example they are in contact within the die.

Alternatively, composite films may be manufactured by consecutive in-line extrusion, wherein a layer is extruded onto the stack one at a time, or any combination of coextrusion and in-line extrusion. Composite films may also be manufactured by laminating the layers together as is known in the art. Additionally, composite films may be manufactured by any combination of coextrusion, in-line extrusion, and lamination.

Coextruded composite film may further be processed, for example by orientation. One example of orientation of a film is biaxial orientation. Biaxial orientation involves stretching the film in two directions perpendicular to each other, generally in the down-web direction and cross-web direction. In a typical operation, the freshly extruded molten film is fed onto a chill roll to produce a quenched amorphous film which is briefly heated and stretched in the down-web direction, and then conducted through a tenter frame where it is stretched transversely with moderate heating. Down-web direction stretching may be accomplished by passing between two sets of nip rolls, the second set rotating at a higher speed than the first.

### Select Embodiments of the Present Disclosure

In a first embodiment, the present disclosure provides a composite film comprising:
a first layer comprising a first copolymer of monomers comprising tetrafluoroethylene, hexafluoropropylene, and vinylidene fluoride, wherein the first copolymer contains at least 35 mole percent of vinylidene fluoride monomer units; and
a second layer disposed on the first layer, wherein the second layer comprises a second copolymer comprising 50 to 83 weight percent of ethylene monomer units and at least 17 weight percent of alkyl (meth)acrylate monomer units represented by the formula

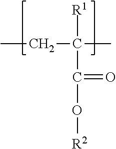

wherein R¹ is H or methyl, and each R² is independently an alkyl group having from 1 to 4 carbon atoms.
In a second embodiment, the present disclosure provides a composite film according to the first embodiment, wherein the first copolymer contains 55 to 80 mole percent of tetrafluoroethylene monomer units, 5 to 17 mole percent of hexafluoropropylene monomer units, and 15 to 50 mole percent of vinylidene fluoride monomer units.

In a third embodiment, the present disclosure provides a composite film according to the first or second embodiment, wherein the second copolymer contains 50 to 82 weight percent of ethylene monomer units, and 18 to 50 weight percent of alkyl (meth) acrylate monomer units.

In a fourth embodiment, the present disclosure provides a composite film according to any one of the first to third embodiments, further comprising a third layer disposed on the first layer and opposite the second layer, wherein the third layer comprises a third copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units.

In a fifth embodiment, the present disclosure provides a composite film according to the fourth embodiment, wherein the third copolymer contains 70 to 80 mole percent of tetrafluoroethylene monomer units, 15 to 20 mole percent of vinylidene fluoride monomer units, and 5 to 9 mole percent of hexafluoropropylene monomer units.

In a sixth embodiment, the present disclosure provides a composite film according to the fourth embodiment, further comprising a fourth layer disposed on the second layer and opposite the first layer, wherein the fourth layer comprises a non-fluorinated polymer.

In a seventh embodiment, the present disclosure provides a composite film according to the sixth embodiment, wherein the fourth layer is a pressure-sensitive adhesive.

In an eighth embodiment, the present disclosure provides a composite film according to the sixth embodiment, further comprising fifth, sixth, and seventh layers, wherein:
the fifth layer is disposed on the fourth layer opposite the second layer, wherein the fifth layer comprises a fifth copolymer comprising 50 to 83 weight percent of ethylene monomer units and at least 17 weight percent of alkyl (meth)acrylate monomer units represented by the formula

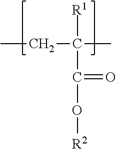

wherein R¹ is H or methyl, and each R² is independently an alkyl group having from 1 to 4 carbon atoms.
the sixth layer is disposed on the fifth layer opposite the fourth layer, wherein the sixth layer comprises a sixth copolymer of monomers comprising tetrafluoroethylene, hexafluoropropylene, and vinylidene fluoride, wherein the sixth copolymer contains at least 35 mole percent of vinylidene fluoride monomer units; and
the seventh layer is disposed on the sixth layer opposite the fourth layer, wherein the seventh layer comprises a seventh copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units.

In a ninth embodiment, the present disclosure provides a composite film according to the sixth or eighth embodiment, wherein the non-fluorinated polymer comprises a polyethylene.

In a tenth embodiment, the present disclosure provides a composite film according to the ninth embodiment, wherein the composite film comprises a tape.

In an eleventh embodiment, the present disclosure provides a heat-sealable protective article comprising a composite film according to any one of the first to sixth embodiments in the form of a tube or pouch, wherein upon heat sealing the heat-sealable protective article to itself, a volume is enclosed that is bounded by the composite film and at least one heat-sealed bond.

In a twelfth embodiment, the present disclosure provides a heat-sealable article according to the eleventh embodiment, wherein the heat-sealable article is a tube, and the second layer is disposed inside the tube.

In a thirteenth embodiment, the present disclosure provides a heat-sealable article according to the eleventh or twelfth embodiment, wherein a substrate is disposed within the tube, wherein the substrate comprises at least one of: wood; paper; natural and/or synthetic fibers which may be woven, nonwoven, or loose; furniture; fiber-polymer composite boards; polymer films; polymer foam; polymer mesh; polymer pipes; polymer tubes; cross-linked polymer composites; metal mesh; metal fibers; metal wires; or a combination thereof.

In a fourteenth embodiment, the present disclosure provides an article comprising a nonwoven fiber web disposed within a heat-sealed heat-sealable protective article according to any one of the eleventh to thirteenth embodiments.

In a fifteenth embodiment, the present disclosure provides a method of making a composite film, the method comprising coextruding:
a first layer comprising a first copolymer of monomers comprising tetrafluoroethylene, hexafluoropropylene, and vinylidene fluoride, wherein the first copolymer contains at least 35 mole percent of vinylidene fluoride monomer units; and
a second layer in intimate contact with the first layer, wherein the second layer comprises a second copolymer comprising 50 to 83 weight percent of ethylene monomer units and at least 17 weight percent of alkyl (meth)acrylate monomer units represented by the formula

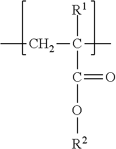

wherein R¹ is H or methyl, and each R² is independently an alkyl group having from 1 to 4 carbon atoms.
In a sixteenth embodiment, the present disclosure provides a method according to the fifteenth embodiment, wherein the first copolymer contains 55 to 80 mole percent of tetrafluoroethylene monomer units, 5 to 17 mole percent of hexafluoropropylene monomer units, and 15 to 50 mole percent of vinylidene fluoride monomer units.

In a seventeenth embodiment, the present disclosure provides a method according to the fifteenth or sixteenth embodiment, wherein the second copolymer contains 50 to 82 weight percent of ethylene monomer units, and 18 to 50 weight percent of alkyl (meth) acrylate monomer units.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight.

Abbreviations: “mol %” means mole percent, and “wt.” means weight.

### Polymers Used in the Examples

Copolymer of 39 mol % tetrafluoroethylene (TFE), 11 mol % hexafluoropropylene (HFP), and 50 mol % vinylidene difluoride (VDF), obtained as 3M DYNEON FLUOROPLASTIC THV 221 fluorothermoplastic from 3M Company, Saint Paul, Minn.

Ethylene-vinyl acetate copolymer (82/18 wt.:wt.), obtained as ELVAX 460 EVA copolymer resin from E. I. du Pont de Nemours & Company, Wilmington, Del.

Copolymer of 72.5 mol % tetrafluoroethylene (TFE), 7 mol % hexafluoropropylene (HFP), 19 mol % vinylidene difluoride (VDF), and 1.5 mol % perfluoropropyl vinyl ether (PPVE-1), obtained as 3M DYNEON FLUOROPLASTIC THV 815 fluorothermoplastic from 3M Company.

Ethylene-vinyl acetate copolymer (92.5/7.5 wt.:wt.), available as BYNEL 3120 from E. I. du Pont de Nemours & Company.

Low density polyethylene (available as LDPE 955 low density polyethylene from Dow Chemical Company, Midland, Mich.

Ethylene-methyl acrylate copolymer (75/25 wt.:wt.) obtained as ELVALOY AC 1125 from E. I. du Pont de Nemours & Company.

Copolymer of 10 mol % hexafluoropropylene (HFP), 45 mol % tetrafluoroethylene (TFE), and 45 mol % ethylene (E), obtained as 3M DYNEON HTE 1705 fluoroplastic from 3M Company.

Copolymer of 90 mol % vinylidene difluoride (VDF), 10 mol % hexafluoropropylene (HFP), obtained as 3M DYNEON FLUOROPLASTIC PVDF 11010/000 fluorothermoplastic from 3M Company.

Copolymer of 61 mol % tetrafluoroethylene (TFE), 10.5 mol % hexafluoropropylene (HFP), and 28.5 mol % vinylidene fluoride (VDF), obtained as 3M DYNEON THV 610 fluorothermoplastic from 3M Company.

Low density polyethylene obtained as LDPE 611A low density polyethylene from Dow Chemical Company.

Copolymer of 39% tetrafluoroethylene (TFE), 11% hexafluoropropylene (HFP), and 50% vinylidene difluoride (VDF), obtained as 3M DYNEON FLUOROPLASTIC THV 220 fluorothermoplastic from 3M Company.

Ethylene-methyl acrylate copolymer (91/9 wt.:wt.) obtained as ELVALOY AC 1609 from E. I. du Pont de Nemours & Company.

Ethylene-methyl acrylate copolymer (82/18 wt.:wt.) obtained as ELVALOY AC 1218 from E. I. du Pont de Nemours & Company.

Ethylene-butyl acrylate copolymer (83/17 wt.:wt.) obtained as ELVALOY AC 3117 from E. I. du Pont de Nemours & Company.

Ethylene-ethyl acrylate copolymer (81.5/18.5 wt.:wt.) obtained as AMPLIFY EA 102 from Dow Chemical Company.

Ethylene-methyl methacrylate copolymer (82/18 wt.:wt.) obtained as ACRYFT WH 303 from Sumitomo Chemical Co. Ltd., Tokyo, Japan.

### Interlayer Adhesion Test

The Interlayer Adhesion Test method was determined using ASTM D1876-08e1 (2015) “Standard Test Method for Peel Resistance of Adhesives (T-Peel Test)” as a guide. More specifically, the test method used to measure interlayer adhesion was as follows. The multilayer film to be tested was cut into 25 cm long by 2.5 cm wide pieces. Each piece was laminated to the center of a 25 cm long by 7.5 cm wide glass plate using 2.5 cm wide double-stick adhesive tape (#665, obtained from 3M Company). One end of the taped film assembly was cut back 1 cm from one end with a razor blade. To each laminate a 2.5 cm wide single-sided adhesive tape (#396, from 3M Company) was applied. Then, the single-sided tape was snapped back over the scored film to initiate delamination of the multilayer film and create an attachment tab. The film-glass plate assembly was installed into the plate holder on a slip/peel tester (MODEL SP-2000 from MASS Inc., Accord, Mass.). The slip/peel tester speed was set at 150 cm/min. The film/tape attachment tab was attached to the transducer clamp of the slip/peel tester. The average force to delaminate the film over a 24 cm length was recorded. The interlayer adhesion value reported was the average based on testing 5 samples of the film. If the multilayer film could not be peeled apart at layer interface then the interlayer adhesion equivalent to maximum force measurable by the force transducer (i.e., 400 grams/centimeter) was recorded.

### Comparative Example A

### 3-Layer Film

Fluoroplastic THV 221 was coextruded with ELVAX 460 ethylene-vinyl acetate copolymer using a 3-manifold die at a temperature of 500° F. (260° C.) onto a casting wheel operating at 70° F. (21° C.) and 20 feet per minute (fpm, 6.1 m/min) to create a 4 mil (102 micron) thick film having a core layer of ELVAX 460 that was 2 mil (51 microns) thick and THV 221 skin layers that were each 1 mil (25 microns) thick. Interlayer adhesion of the 3-layer film was measured with a tape peel tester to be 30 grams/inch (11.6 N/m). Results are reported in Table 1.

### Comparative Example B

### 3-Layer Film

Fluoroplastic THV 815 was coextruded with BYNEL 3120 ethylene-vinyl acetate copolymer using a 3-manifold die at a temperature of 500° F. (260° C.) onto a casting wheel operating at 70° F. (21° C.) and 20 fpm (6.1 m/min) to create a 4 mil (102 micron) thick film having a core layer of BYNEL 3120 that was 2 mil (51 microns) thick and THV 815 skin layers that were each 1 mil (25 microns) thick. Interlayer adhesion of the 3-layer film was measured with a tape peel tester to be 25 grams/inch (9.7 N/m). Results are reported in Table 1.

### Comparative Example C

### 3-Layer Film

Seven-layer film specimens were produced using a seven-layer pancake stack die (obtained as TYPE LF-400 COEX 7-LAYER from Labtech Engineering, Praksa, Muang, Samutprakarn, Thailand). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20-mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177 C), Zone 2: 420° F. (216° C.), Zone 3:
480° F. (249° C.); and

Adapter and Die Temperatures: Adapter 480° F. (249° C.), Die 480° F. (249° C.). The LDPE skin layers 5-7 were strippable and were removed, leaving a 3-layer film comprising polyethylene LDPE 955 as layer 1 (the merged original layers 1 and 2), ethylene methyl acrylate copolymer ELVALOY AC 1125 as layer 2, and fluoropolymer HTE 1705 as layer 3. This film was measured to be 3 mils (76 microns) thick. Interlayer adhesion of the 3-layer film was measured with a tape peel tester to be 83 grams/inch (32.0 N/m). Results are reported in Table 1.

### Example 1

### 3-Layer Film

Seven-layer film specimens were produced using a seven layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20-mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).

The LDPE skin layers 5-7 were strippable and were removed, leaving a 3-layer film comprising polyethylene (LDPE 955) as layer 1 (the merged original layers 1 and 2), ethylene methyl acrylate copolymer (ELVALOY AC 1125) as layer 2, and fluorpolymer (THV 221) as layer 3. This film was measured to be 3 mils (76 microns) thick. Interlayer adhesion of the 3-layer film was measured with a tape peel tester to be in excess of 1000 grams/inch (386.1 N/m). Results are reported in Table 1.

### Example 2

### 3-Layer Film

Seven-layer film specimens were produced using a seven layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).

The LDPE skin layers 5-7 were strippable and were removed, leaving a 3-layer film comprising polyethylene (LDPE 955) as layer 1 (the merged original layers 1 and 2), ethylene methyl acrylate copolymer (ELVALOY AC 1125) as layer 2, and fluorpolymer (THV 610) as layer 3. This film was measured to be 3 mils (76 microns) thick. Interlayer adhesion of the 3-layer film was measured with a tape peel tester to be 293 grams/inch (113.1 N/m). Results are reported in Table 1.

### Example 3

### 3-Layer Film

Seven-layer film specimens were produced using a seven layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).

The LDPE skin layers 5-7 were strippable and were removed, leaving a 3-layer film comprising polyethylene (LDPE 955) as layer 1 (the merged original layers 1 and 2), ethylene methyl acrylate copolymer (ELVALOY AC 1125) as layer 2, and fluorpolymer (THV 815) as layer 3. This film was measured to be 3 mils (76 microns) thick. Interlayer adhesion of the 3-layer film was measured with a tape peel tester to be 147 grams/inch (56.8 N/m). Results are reported in Table 1.

### Example 4

### 3-Layer Film

Seven-layer film specimens were produced using a seven-layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).

The LDPE skin layers 1-3 and 7 were strippable and were removed, leaving a 3-layer film comprising fluoropolymer (THV 815) as layer 1 (the original layer 4), ethylene methyl acrylate copolymer (ELVALOY AC 1125) as layer 2, and fluorpolymer (THV 815) as layer 3. This film was measured to be 3 mils (76 microns) thick. Interlayer adhesion of the 3-layer film was measured with a tape peel tester to be 197 grams/inch (76.1 N/m). Results are reported in Table 1.

### Example 5

### 5-Layer Film

Seven-layer film specimens were produced using a seven-layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).

The LDPE skin layers 1 and 7 were strippable and were removed, leaving a 5-layer film comprising fluoropolymer (THV 815) as layer 1 (the original layer 2), fluoropolymer (THV 221) as layer 2, ethylene methyl acrylate copolymer (ELVALOY AC 1125) as layer 3, fluoropolymer (THV 221) as layer 4, and fluorpolymer (THV 815) as layer 5. This film was measured to be 3 mils (76 microns) thick. Interlayer adhesion of the 5-layer film was measured with a tape peel tester to be in excess of 1000 grams/inch (386.1 N/m). Results are reported in Table 1.

### Example 6

### 7-Layer Film

Seven-layer film specimens were produced using a seven-layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer are reported in Table 1. The process temperatures were as follows:
Film layers 1-7 Extruder Temperatures: Zone 1: 350° F. (177° C.), Zone 2: 420° F. (216° C.), Zone 3: 480° F. (249° C.); and
Adapter and Die Temperatures: Adapter 480° F. (249° C.), Die 480° F. (249° C.).
   The film so made was a 7-layer film comprising fluoropolymer (THV 815) as layer 1, fluoropolymer (THV 221) as layer 2, ethylene methyl acrylate copolymer (ELVALOY AC 1125) as layer 3, polyethylene (LDPE 955) as layer 4, ethylene methyl acrylate copolymer (ELVALOY AC 1125) as layer 5, fluoropolymer (THV 221) as layer 6, and fluoropolymer (THV 815) as layer 7. This film was measured to be 3 mils (76 microns) thick. Interlayer adhesion of the 7-layer film was measured with a tape peel tester to be in excess of 1000 grams/inch (386.1 N/m). Results are reported in Table 1.

TABLE 1

| | | | | | | | | INTERLAYER ADHESION, | |
|---|---|---|---|---|---|---|---|---|---|
| EXAMPLE | LAYER 1 | LAYER 2 | LAYER 3 | LAYER 4 | LAYER 5 | LAYER 6 | LAYER 7 | gram/inch (g/cm) | |
| Comp. | THV 221 | Elvax 460 | THV 221 | NA | NA | NA | NA | 30 | (11.8) |
| Ex. A | | | | | | | | | |
| Comp. | THV 815 | Bynel 3120 | THV 815 | NA | NA | NA | NA | 25 | (9.8) |
| Ex. B | | | | | | | | | |
| Comp. | LDPE 955 | LDPE 955 | ELVALOY | HTE 1705 | LDPE 955 | LDPE 955 | LDPE 955 | 83 | (32.7) |
| Ex. C | | | AC 1125 | | | | | | |
| 1 | LDPE 955 | LDPE 955 | ELVALOY | THV 221 | LDPE 955 | LDPE 955 | LDPE 955 | >1000 | (>394) |
| | | | AC 1125 | | | | | | |
| 2 | LDPE 955 | LDPE 955 | ELVALOY | THV 610 | LDPE 955 | LDPE 955 | LDPE 955 | 293 | (115) |
| | | | AC 1125 | | | | | | |
| 3 | LDPE 955 | LDPE 955 | ELVALOY | THV 815 | LDPE 955 | LDPE 955 | LDPE 955 | 147 | (57.9) |
| | | | AC 1125 | | | | | | |
| 4 | LDPE 955 | LDPE 955 | LDPE 955 | THV 815 | ELVALOY | THV 815 | LDPE 955 | 197 | (77.6) |
| | | | | | AC 1125 | | | | |
| 5 | LDPE 955 | THV 815 | THV 221 | Elvaloy | THV 221 | THV 815 | LDPE 955 | >1000 | (>394) |
| | | | | AC 1125 | | | | | |
| 6 | THV 815 | THV 221 | ELVALOY | LDPE 955 | Elvaloy | THV 221 | THV 815 | >1000 | (>394) |
| | | | AC 1125 | | AC 1125 | | | | |

### Examples 7-11 and Comparative Example e

Three-layer film specimens were produced using a three-layer blown film line (obtained as SCIENTIFIC LABORATORY ULTRAMICRO MULTILAYER FILM BLOWING TYPE LUMF-150 COEX from Labtech Engineering). Airflow to the die was manually controlled to achieve a blow-up ratio of approximately 2:1. The bubble was subsequently collapsed approximately one foot (0.3 meters) above the die, and then rolled up. The feed materials were supplied by 3 conical single screw extruders (obtained as TYPE LE8-30C from Labtech Engineering). The process temperatures were as follows:
Inside Extruder: 390° F. (199° C.)
Middle Extruder: 390° F. (199° C.)
Outside Extruder: 450° F. (232° C.)
Bottom Die Temperature: 410° F. (210° C.)
Middle Die Temperature: 420° F. (216° C.)
Top Die Temperature: 430° F. (221° C.)
   Results are reported in Table 2, below.

TABLE 2

| | | | | INTERLAYER ADHESION, |
|---|---|---|---|---|
| EXAMPLE | INNER LAYER | CENTER LAYER | OUTER LAYER | gram/inch (g/cm) |
| 7 | LDPE 611A | ELVALOY AC 1218 | THV 220 | 265.1 (104.4) |
| 8 | LDPE 611A | AMPLIFY EA 102 | THV 220 | 361.5 (142.3) |
| 9 | LDPE 611A | ELVALOY AC 3117 | THV 220 | 318.1 (125.2) |
| 10 | LDPE 611A | ACRYFT WH 303 | THV 220 | 179.4 (70.5) |
| 11 | LDPE 611A | ELVALOY AC 1125 | THV 220 | 413.5 (162.8) |
| Comp. | LDPE 611A | ELVALOY AC 1609 | THV 220 | 97.3 (38.3) |
| Ex. E | | | | |

### Example 13

Following the UL 94V vertical burning protocol, flammability was evaluated.

A seven-layer film precursor to a three-layer film was produced using a seven-layer pancake stack die (obtained as TYPE LF-400 COEX 7-LAYER from Labtech Engineering). Airflow to the die was manually controlled to achieve a blow-up ratio of approximately 2:1. The bubble was subsequently collapsed approximately ten feet (3.0 meters) above the die, and then rolled up. The feed materials were supplied by 7 independent 20 mm diameter single screw extruders with an approximately 30:1 L/D ratio. Each extruder utilized a screw with compression ratio of 2:1 and no mixing section. Polymers used in each layer were, in order, LDPE 995 in layers 1-4, followed by THV 815, THV 221, and ELVALOY AC 1125. The process temperatures were as follows:
Film layers 1-7 Extruder Temperatures: Zone 1: 350° F. (177° C.), Zone 2: 420° F. (216° C.), Zone 3:
480° F. (249° C.); and

Adapter and Die Temperatures: Adapter 480° F. (249° C.), Die 480° F. (249° C.). The LDPE skin layers 1-4 were strippable and were removed, leaving a 3-layer film comprising fluoropolymer (THV 815) as layer 1 (the original layer 5), fluoropolymer (THV 221) as layer 2, and (ELVALOY AC 1125) as layer 3. Interlayer adhesion of the 3-layer film was measured with a tape peel tester to be in excess of 1000 grams/inch (386.1 N/m).

A test specimen was cut 6 inches tall by 4 inches wide (15 cm×10 cm) and mounted vertically. A Bunsen burner with 20-mm tall flame was moved underneath the sample with a 10-mm portion of the flame in contact with the specimen bottom edge. The specimen shrank upward away from the flame. The flame was moved upward as UL 94V requires, and the melted region was more than 5 inches (13 cm). Thus, the specimen failed UL 94V when burnt as a stand-alone specimen.

### Example 14

The film of Example 13 was wrapped around a nonmeltable nonwoven mat. The nonwoven mat was a mix of 80% oxidized polyacrylonitrile carbon fibers (obtained as ZOLTEK PN37ST050-17D OX OPAN from Toray Industries, St. Louis, Mo.) and 20% flame retardant bicomponent staple fiber of copolyolefin, 3.3 dTex (obtained as TREVIRA 276 from Trevira GmbH, Hattersheim, Germany). These fibers were carded to form a 150 gm/m² 5-mm thick web. An oven was used, at 150 C, to activate the TREVIRA 276 binder to bind the OPAN web together.

The film of Example 13 was wrapped around the nonwoven mat, with the Elvaloy AC 1125 layer on the inside, and the UL 94 (1996), Underwriters Laboratory, entitled “Test of Flammability of Plastic Materials for Parts in Devices and Appliances” test was followed. There was fire propagation, and dripping was observed. After the Bunsen burner was moved away, the flame self-extinguished 17 seconds later. Thus, the combined specimen (film wrapped around nonwoven) was judged to have passed the UL 94, V-2 classification.

### Example 15

The film of Example 13 was wrapped around a nonmeltable nonwoven mat, which had no PP/PET binder. The nonwoven mat was 100% oxidized polyacrylonitrile carbon fibers ZOLTEK PN37ST050-17D OX OPAN. These fibers were carded and needletacked to form a 150 gm/m², 8-mm thick web.

The ELVALOY AC 1125 layer was on the inside, and the UL 94 (1996) procedure was followed. There was fire propagation, followed by the fire being self-extinguished even with the Bunsen burner still underneath. The flame height was raised to less than 5 inches (12.5 cm) as the film melted away less than 5 inches (12.5 cm). Thus, the combined specimen (film wrapped around nonwoven) was judged to have passed the more stringent UL 94, VO classification.

### Comparative Example D

Specimens were also evaluated for flame resistance according to the U. S. Federal Aviation Regulations FAR 25.853(a) flammability standard.

Gas flow rate was adjusted so that the Bunsen burner had flame height of 1 inch (2.54 cm). The specimen was mounted vertically so that the bottom of the sample was 0.5 inch (1.27 cm) higher than the tip of the Bunsen burner nozzle. In other words, the sample bottom reached the middle of the flame. For a thick test specimen like the 10 inches by 4 inches by 1 inch (25 cm by 10 cm by 2.5 cm) wood block used for this Comparative Example, the front face of the block reached the vertical centerline of the flame. In other words, the test specimen was inside the top right quadrant of the flame. Following the FAR 25.853(a) method, the Bunsen burner was moved underneath the wood test specimen for 1 minute and then moved away. After the Bunsen burner moved away, the flame on the test specimen should be self-extinguished within 15 seconds. The flame propagation should be less than 6 inches (15 cm). However, for this test specimen, the flame kept burning after removal of the Bunsen burner, and propagated up to 10 inches (25 cm). There was no self-extinguishment until 60 seconds later. The wood test specimen alone failed the FAR 25-853a test.

### Example 16

For this test, the front side of a wood block identical to that used in Comparative Example D, was covered with the film of Example 13, with the ELVALOY AC 1125 layer on the inside. After the Bunsen burner 1-min burn and burner removal, the flame self-extinguished within 10 seconds. The burn mark on the wood block only reached 4 inches (10 cm) high. The combined test specimen (film wrapped around wood block) was judged to have passed the FAR 25.853(a) standard.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-17. (canceled)

18. A composite film comprising:
a first layer comprising a first copolymer of monomers comprising tetrafluoroethylene, hexafluoropropylene, and vinylidene fluoride, wherein the first copolymer contains at least 15 mole percent of vinylidene fluoride monomer units; and
a second layer disposed on the first layer, wherein the second layer comprises a second copolymer comprising 50 to 83 weight percent of ethylene monomer units and at least 17 weight percent of alkyl (meth)acrylate monomer units represented by the formula 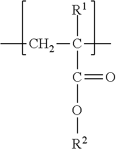
wherein R¹ is H or methyl, and each R² is independently an alkyl group having from 1 to 4 carbon atoms.

19. The composite film of claim 18, wherein the first copolymer contains 55 to 80 mole percent of tetrafluoroethylene monomer units, 5 to 17 mole percent of hexafluoropropylene monomer units, and 15 to 50 mole percent of vinylidene fluoride monomer units.

20. The composite film of claim 18, wherein the second copolymer contains 50 to 82 weight percent of ethylene monomer units, and 18 to 50 weight percent of methyl acrylate monomer units.

21. The composite film of claim 18, further comprising a third layer disposed on the first layer and opposite the second layer, wherein the third layer comprises a third copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units.

22. The composite film of claim 21, wherein the third copolymer contains 70 to 80 mole percent of tetrafluoroethylene monomer units, 15 to 20 mole percent of vinylidene fluoride monomer units, and 5 to 9 mole percent of hexafluoropropylene monomer units.

23. The composite film of claim 21, further comprising a fourth layer disposed on the second layer and opposite the first layer, wherein the fourth layer comprises a non-fluorinated polymer.

24. The composite film of claim 23, wherein the fourth layer is a pressure-sensitive adhesive.

25. The composite film of claim 23, further comprising fifth, sixth, and seventh layers, wherein:
the fifth layer is disposed on the fourth layer opposite the second layer, wherein the fifth layer comprises a fifth copolymer comprising 50 to 83 weight percent of ethylene monomer units and at least 17 weight percent of alkyl (meth)acrylate monomer units represented by the formula 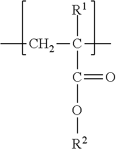
wherein R¹ is H or methyl, and each R² is independently an alkyl group having from 1 to 4 carbon atoms;
the sixth layer is disposed on the fifth layer opposite the fourth layer, wherein the sixth layer comprises a sixth copolymer of monomers comprising tetrafluoroethylene, hexafluoropropylene, and vinylidene fluoride, wherein the sixth copolymer contains at least 35 mole percent of vinylidene fluoride monomer units; and
the seventh layer is disposed on the sixth layer opposite the fourth layer, wherein the seventh layer comprises a seventh copolymer of monomers comprising tetrafluoroethylene, hexafluoropropylene, and vinylidene fluoride, wherein the third copolymer contains at least 50 mole percent of tetrafluoroethylene monomer units, at least 15 mole percent of vinylidene fluoride monomer units, and at least 5 mole percent of hexafluoropropylene monomer units.

26. The composite film of claim 23, wherein the non-fluorinated polymer comprises a polyethylene.

27. The composite film of claim 26, wherein the composite film comprises a tape.

28. A heat-sealable protective article comprising the composite film of claim 18 in the form of a tube or pouch, wherein upon heat sealing the heat-sealable protective article to itself, a volume is enclosed that is bounded by the composite film and at least one heat-sealed bond.

29. The heat-sealable article of claim 28, wherein the heat-sealable article is a tube, and the second layer is disposed inside the tube.

30. The heat-sealable article of claim 28, wherein a substrate is disposed within the tube, wherein the substrate comprises at least one of: wood; paper; natural and/or synthetic fibers which may be woven, nonwoven, or loose; furniture; fiber-polymer composite boards; polymer films; polymer foam; polymer mesh; polymer pipes; polymer tubes; cross-linked polymer composites; metal mesh; metal fibers; metal wires; ceramic fibers; glass fibers; or a combination thereof.

31. An article comprising a nonwoven fiber web disposed within a heat-sealed heat-sealable protective article of claim 28.

32. A method of making a composite film, the method comprising coextruding:
a first layer comprising a first copolymer of monomers comprising tetrafluoroethylene, hexafluoropropylene, and vinylidene fluoride, wherein the first copolymer contains at least 15 mole percent of vinylidene fluoride monomer units; and
a second layer in intimate contact with the first layer, wherein the second layer comprises a second copolymer comprising 50 to 83 weight percent of ethylene monomer units and at least 17 weight percent of alkyl (meth)acrylate monomer units represented by the formula 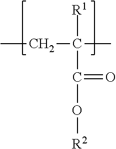
wherein R¹ is H or methyl, and each R² is independently an alkyl group having from 1 to 4 carbon atoms.

33. The method of claim 32, wherein the first copolymer contains 55 to 80 mole percent of tetrafluoroethylene monomer units, 5 to 17 mole percent of hexafluoropropylene monomer units, and 15 to 50 mole percent of vinylidene fluoride monomer units.

34. The method of claim 32, wherein the second copolymer contains 50 to 82 weight percent of ethylene monomer units, and 18 to 50 weight percent of alkyl (meth) acrylate monomer units.
